(19) United States
(12) Patent Application Publication
(10) Pub. No.: US 2010/0187035 A1
(43) Pub. Date: Jul. 29, 2010

(54) ELECTRIC GOLF BAG CART

(75) Inventor: Paul Lin, Tainan Hsien (TW)

Correspondence Address: TUROCY & WATSON, LLP, 127 Public Square, 57th Floor, Key Tower, CLEVELAND, OH, 44114, US

(73) Assignee: MACAUTO INDUSTRIAL CO., LTD, Tainan Hsien (TW)

(21) Appl. No.: 12/361,710

(22) Filed: Jan. 29, 2009

(51) Int. Cl. B62D 51/04; B62D 61/08

(52) U.S. Cl. 180/211; 180/19.3; 180/65.6; 180/68.5

(57) ABSTRACT

An electric golf bag cart includes a cart body unit having at least one first engaging portion, a pair of rear wheel units connected to the cart body unit, an electrically operable power front wheel unit coupled to the cart body unit and electrically operable to cooperate with the rear wheel units for moving the cart body unit on a ground surface, and a battery unit having at least one second engaging portion that is coupled detachably to the first engaging portion of the cart body unit, and connected electrically to the power front wheel unit.

### BACKGROUND OF THE INVENTION

1. Field of the Invention

The invention relates to a golf bag cart, more particularly to an electric golf bag cart.

2. Description of the Related Art

A conventional electric golf bag cart generally comprises a cart frame, a front wheel coupled to a bottom part of the cart frame, a pair of spaced-apart rear wheels coupled to the cart frame, an electric driving device disposed between the rear wheels and connected to the rear wheels, and a battery mounted securely on the cart frame and connected electrically to the electric driving device. Therefore, the rear wheels can be driven to rotate by the electric driving device, thereby resulting in movement of the entire conventional electric golf bag cart.

However, since the battery is mounted non-removably on the cart frame and is relatively large and heavy, it is inconvenient to store and transport the conventional electric golf bag cart after use.

### SUMMARY OF THE INVENTION

Therefore, the object of the present invention is to provide an electric golf bag cart that has a detachable battery unit, and that is convenient to store and transport.

Accordingly, an electric golf bag cart of the present invention comprises a cart body unit having at least one first engaging portion, a pair of rear wheel units connected to the cart body unit, an electrically operable power front wheel unit coupled to the cart body unit and electrically operable to cooperate with the rear wheel units for moving the cart body unit on a ground surface, and a battery unit having at least one second engaging portion that is coupled detachably to the first engaging portion of the cart body unit, and connected electrically to the power front wheel unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of an electric golf bag cart according to the invention;

FIG. 2 is a side view of the preferred embodiment in a folded state;

FIG. 3 is an exploded perspective view of a battery coupling seat, an electric driving unit, and a power front wheel unit of the preferred embodiment;

FIG. 4 is an exploded perspective view to illustrate a connection relationship between the battery coupling seat and a battery unit of the preferred embodiment;

FIG. 5 is a bottom view of a pivot seat of the preferred embodiment; and

FIG. 6 is a fragmentary assembled side view of the battery coupling seat, the electric driving unit, and the power front wheel unit of the preferred embodiment.

### DETAILED DESCRIPTION OF THE PREFERRED EMBODIMENT

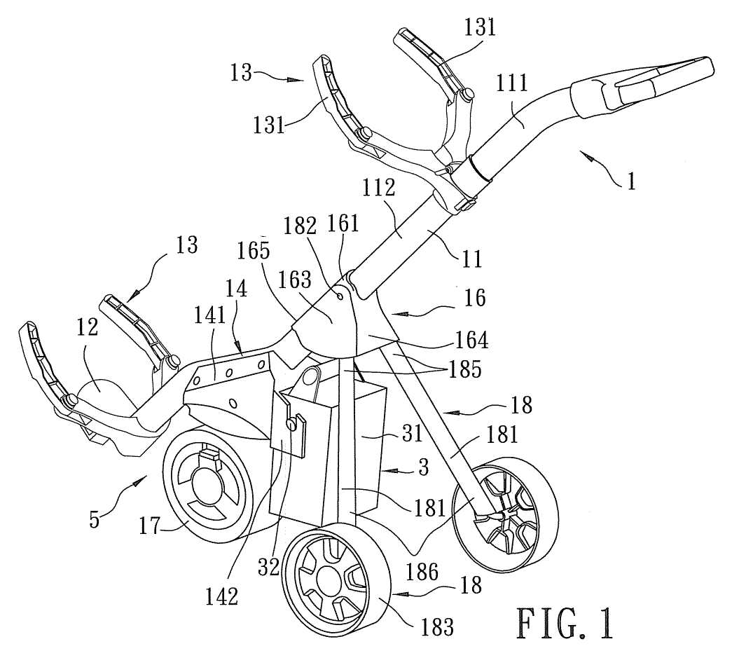

As shown in FIGS. 1 to 3, the preferred embodiment of an electric golf bag cart according to the present invention comprises a cart body unit 1, an electric driving unit 2, a pair of rear wheel units 18, an electrically operable power front wheel unit 5, and a battery unit 3.

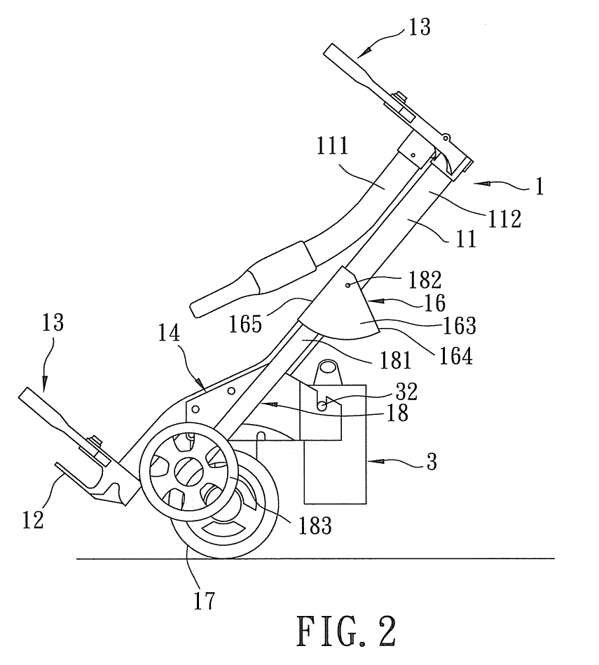

The cart body unit 1 includes a cart frame 11, a support seat 12 connected to a bottom end of the cart frame 11 and adapted for supporting a golf bag (not shown) thereon, a pair of spaced apart retaining mechanisms 13 mounted on the cart frame 11, a battery coupling seat 14, and a pivot seat 16. The cart frame 11 includes an upper section 111 and a bottom section 112 connected foldably to a bottom end of the upper section 111. The cart frame 11 is foldable from a normal state (see FIG. 1) to a folded state (see FIG. 2), where the upper section 111 thereof is folded downwardly to overlap the bottom section 112 thereof. Each of the retaining mechanisms 13 includes a pair retaining arms 131 movable for retaining the golf bag on the cart body unit 1. Since the feature of this invention does not reside in the specific configuration of the retaining mechanisms 13, further details of the same are omitted herein for the sake of brevity.

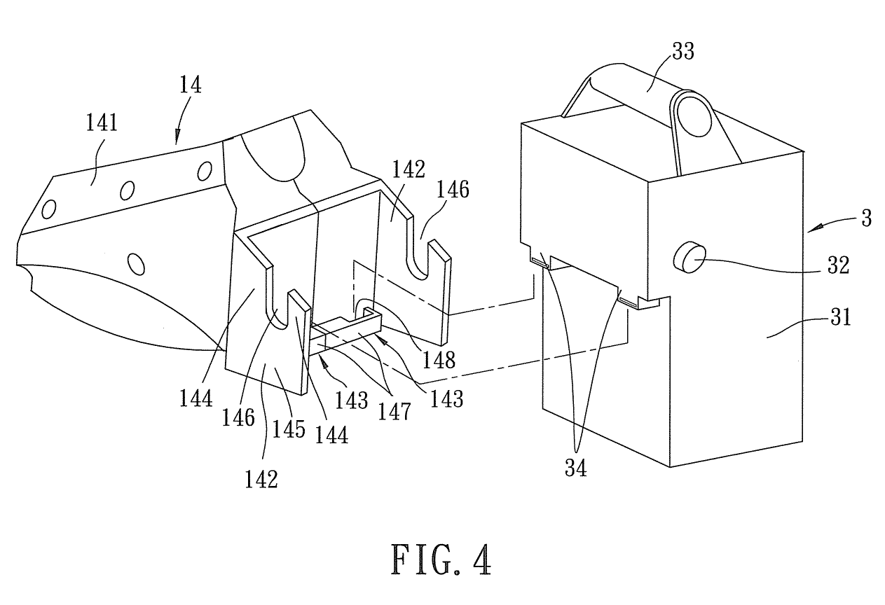

Referring to FIGS. 1, 3 and 4, the battery coupling seat 14 is coupled to the bottom section 112 of the cart frame 11, and includes a pair of seat body parts 140 coupled to each other. In this embodiment, the battery coupling seat 14 has a main portion 141 that is mounted on the bottom section 112 of the cart frame 11 using screws (not shown) and that is formed with a pair of first engaging portions 142 spaced apart from each other in a left-right direction, and a pair of conducting portions 143 projecting from a rear side of the main portion 141. Each of the first engaging portions 142 has a pair of end sections 144 spaced apart from each other in a front-rear direction, and an intermediate section 145 interconnecting bottom parts of the end sections 144 and cooperating with the end sections 144 to define an engaging groove 146 thereamong. Each of the conducting portions 143 includes a surrounding wall 147 connected to the main portion 141 and cooperating with the main portion 141 to define a socket 148 that opens upwardly.

In this embodiment, the rear wheel units 18 are connected pivotally to the bottom section 112 of the cart frame 11 of the cart body unit 1 above the battery coupling seat 14. Each of the rear wheel units 18 includes a connecting rod 181 that has a connecting end portion 185 connected pivotally to the bottom section 112 of the cart frame 11, and a distal end portion 186 opposite to the connecting end portion 185. Each of the rear wheel units 18 further includes a rear wheel 183 connected rotatably to the distal end portion 186 of the connecting rod 181.

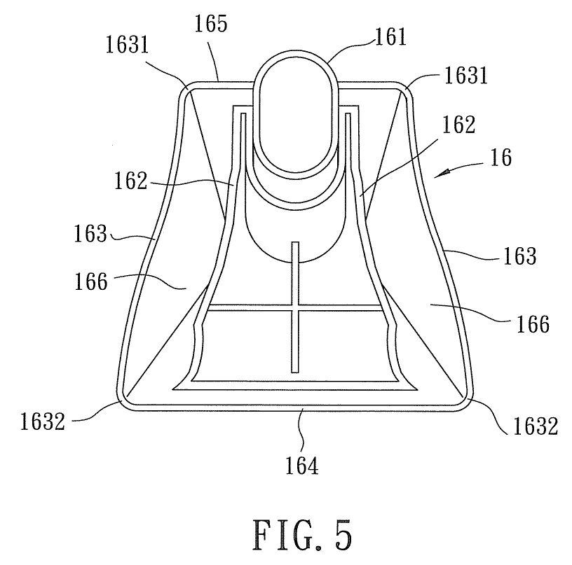

As shown in FIGS. 1, 2 and 5, the pivot seat 16 is mounted to the bottom section 112 of the cart frame 11 of the cart body unit 1 and is connected pivotally to the connecting end portions 185 of the connecting rods 181 of the rear wheel units 18 via a pivot pin 182. The pivot seat 16 includes an upper surrounding wall 161 sleeved on the bottom section 112 of the cart frame 11, a pair of spaced-apart side walls 163 extending downwardly and respectively from left and right sides of the upper surrounding wall 161 and each having opposite front and rear edges 1631, 1632, a front wall 165 interconnecting the front edges 1631 of the side walls 163, a rear wall 164 interconnecting the rear edges 1632 of the side walls 163, and a pair of spaced-apart inner walls 162, each of which is disposed between the side walls 163, interconnects the front and rear walls 165, 164, and cooperates with an adjacent one of the side walls 163 and the front and rear walls 165, 164 to define a pivot space 166 thereamong for receiving pivotally the connecting end portion 185 of the connecting rod 181 of a corresponding one of the rear wheel units 18.

In this embodiment, each of the rear wheel units 18 is pivotable relative to the cart frame 11 of the cart body unit 1 between an unfolded position (see FIG. 1), where the connecting rod 181 is adjacent to the rear wall 164 of the pivot seat 16 of the cart body unit 1 and the rear wheel 183 is disposed away from the power front wheel unit 5, and a folded position (see FIG. 2), where the connecting rod 181 is disposed adjacent to the front wall 165 of the pivot seat 16 and the rear wheel 183 is adjacent to the power front wheel unit 5.

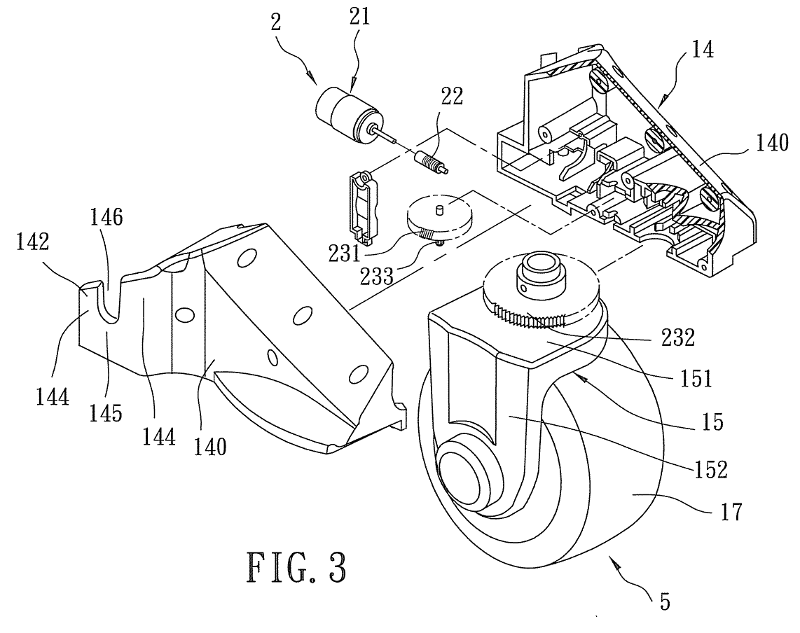

Referring to FIG. 3, the power front wheel unit 5 is coupled to the battery coupling seat 14 of the cart body unit 1 and is electrically operable to cooperate with the rear wheel units 18 for moving the cart body unit 1 on a ground surface. In this embodiment, the power front wheel unit 5 is coupled rotatably to a bottom side of the battery coupling seat 14 of the cart body unit 1 so as to be rotatable relative to the cart body unit 1 about a normal axis that is normal to the ground surface, thereby permitting change in direction of movement of the cart body unit 1 on the ground surface. The power front wheel unit 5 includes a driven gear 232 retained in the battery coupling seat 14 of the cart body unit 1 and rotatable about the normal axis, and a wheel mounting seat 15 connected co-rotatably to the driven gear 232 and carrying rotatably a front wheel 17. The wheel mounting seat 15 includes a top wall disposed between the battery coupling seat 14 and the front wheel 17, and a wheel connecting wall 152 extending downwardly from one end of the top wall 151 and coupled rotatably to the front wheel 17.

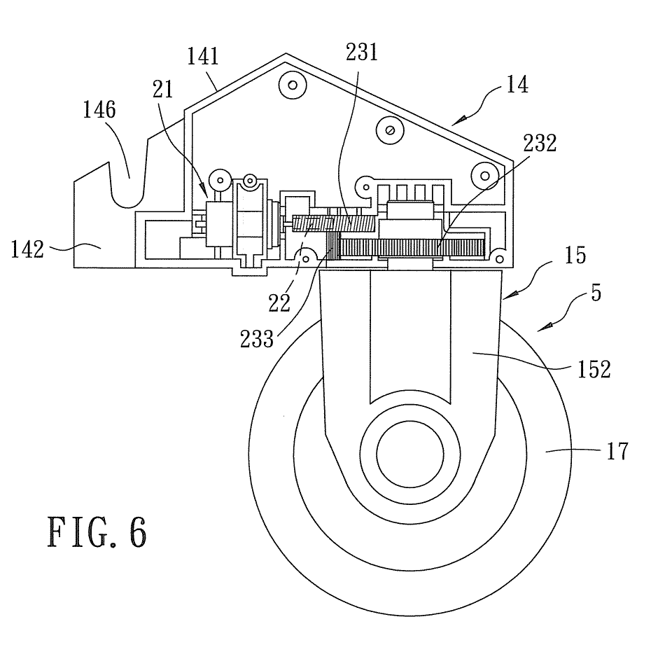

As shown in FIGS. 1, 3 and 6, in this embodiment, the electric driving unit 2 is disposed in the main portion 141 of the battery coupling seat 14 of the cart body unit 1, and includes a motor 21 having a drive component 22, a driving gear 231 meshing with the drive component 22, and a coupling gear 233 projecting from one side of the driving gear 231 at a position offset from a gear axis of the driving gear 231 and meshing with the driven gear 232 of the power front wheel unit 5.

Referring once again to FIGS. 1, 3 and 4, the battery unit 3 includes a battery body 31 and a handle 33 disposed at a top side of the battery body 31. In this embodiment, the battery body 31 has a pair of second engaging portions 32 (only one is visible) protruding from lateral sides thereof and engaging respectively and detachably the first engaging portions 142 of the battery coupling seat 14 of the cart body unit 1. The battery body 31 further has a pair of inserting portions 34 protruding therefrom and extending fittingly, removably and respectively into the sockets 148 in the conducting portions 143 of the battery coupling seat 14. In this embodiment, each of the sockets 148 in the battery coupling seat 14 is provided with a contact plate connected to the electric driving unit 2 and the power front wheel unit 5, while each of the inserting portions 34 is provided with a contact plate, such that the battery unit 3 is connected electrically to the power front wheel unit 5 and the electric driving unit 2 via engagement between the sockets 148 and the inserting portions 34.

Therefore, before use, the battery unit 3 can be coupled to the battery coupling seat 14 of the cart body unit 1 by inserting downwardly and respectively the second engaging portions 32 of the battery body 31 into the engaging grooves 146 of the first engaging portions 142 on the battery coupling seat 14. After use, the battery unit 3 can be removed from the battery coupling seat 14 of the cart body unit 1 by disengaging the second engaging portions 32 from the engaging grooves 146 of the first engaging portions 142. Moreover, the electric golf bag cart of this invention can be converted to a more compact size by moving each of the rear wheel units 18 to the folded position and folding the cart frame 11 of the cart body unit 1 to the folded state, thereby effectively facilitating storage and transport of the electric golf bag cart of this invention.

It should be noted that, while this invention is exemplified using a pair of first engaging portions 142 and a pair of the second engaging portions 32, only one first engaging portion 142 and one second engaging portion 32 may be employed in other embodiments of this invention. Moreover, in other embodiments of this invention, each of the first engaging portions 142 may be in a form of a protrusion, while each of the second engaging portions 32 may be in a form of a groove.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric golf bag cart comprising:
a cart body unit having at least one first engaging portion;
a pair of rear wheel units connected to said cart body unit;
an electrically operable power front wheel unit coupled to said cart body unit and electrically operable to cooperate with said rear wheel units for moving said cart body unit on a ground surface; and
a battery unit having at least one second engaging portion that is coupled detachably to said at least one first engaging portion of said cart body unit, and connected electrically to said power front wheel unit.

2. The electric golf bag cart as claimed in claim 1, wherein:
said power front wheel unit is coupled rotatably to said cart body unit so as to be rotatable relative to said cart body unit about a normal axis that is normal to the ground surface, thereby permitting change in direction of movement of said cart body unit on the ground surface; and
said electric golf bag cart further comprises an electric driving unit disposed on said cart body unit and coupled to said power front wheel unit for driving rotation of said power front wheel unit about the normal axis.

3. The electric golf bag cart as claimed in claim 2, wherein:
said cart body unit includes a cart frame, and a battery coupling seat coupled to said electric driving unit and having a main portion that is mounted on said cart frame, and that is formed with said at least one first engaging portion; and
said battery unit includes a battery body formed with said at least one second engaging portion.

4. The electric golf bag cart as claimed in claim 3, wherein:
one of said first engaging portion of said battery coupling seat of said cart body unit and said second engaging portion of said battery body of said battery unit is in a form of a protrusion; and
the other one of said first and second engaging portions is in a form of a groove.

5. The electric golf bag cart as claimed in claim 3, wherein:
said battery coupling seat of said cart body unit has a spaced-apart pair of said first engaging portions, each of which has a pair of spaced-apart end sections, and an intermediate section interconnecting said end sections and cooperating with said end sections to define an engaging groove thereamong; and
said battery body of said battery unit has a pair of said second engaging portions protruding therefrom and engaging respectively and detachably said first engaging portions.

6. The electric golf bag cart as claimed in claim 3, wherein:
said battery coupling seat of said cart body unit further has a pair of conducting portions projecting from said main portion, each of said conducting portions including a surrounding wall that is connected to said main portion and that cooperates with said main portion to define a socket therebetween; and
said battery body of said battery unit further has a pair of inserting portions protruding therefrom and extending fittingly, removably and respectively into said sockets.

7. The electric golf bag cart as claimed in claim 1, wherein:
said cart body unit includes a cart frame; and
each of said rear wheel units includes
a connecting rod that has a connecting end portion connected pivotally to said cart frame, and a distal end portion opposite to said connecting end portion, and
a rear wheel connected rotatably to said distal end portion of said connecting rod.

8. The electric golf bag cart as claimed in claim 7, wherein said cart body unit further includes a pivot seat mounted to said cart frame and connected pivotally to said connecting end portions of said connecting rods of said rear wheel units, said pivot seat including:
a pair of spaced-apart side walls, each of which has opposite front and rear edges;
a front wall interconnecting said front edges of said side walls;
a rear wall interconnecting said rear edges of said side walls; and
a pair of spaced-apart inner walls, each of which is disposed between said side walls, interconnects said front and rear walls, and cooperates with an adjacent one of said side walls and said front and rear walls to define a pivot space thereamong for receiving pivotally said connecting end portion of said connecting rod of a corresponding one of said rear wheel units;
wherein each of said rear wheel units is pivotable relative to said cart frame of said cart body unit between an unfolded position, where said connecting rod is adjacent to said rear wall and said rear wheel is disposed away from said power front wheel unit, and a folded position, where said connecting rod is disposed adjacent to said front wall and said rear wheel is adjacent to said power front wheel unit.

9. The electric golf bag cart as claimed in claim 2, wherein:
said power front wheel unit includes a driven gear retained on said cart body unit and rotatable about the normal axis; and
said electric driving unit includes a motor having a drive component, a driving gear meshing with said drive component, and a coupling gear projecting from one side of said driving gear at a position offset from a gear axis of said driving gear and meshing with said driven gear.
